(19) United States
(12) Patent Application Publication
(10) Pub. No.: US 2017/0008126 A1
(43) Pub. Date: Jan. 12, 2017

(54) AN ADDITIVE MANUFACTURING SYSTEM WITH A MULTI-ENERGY BEAM GUN AND METHOD OF OPERATION

(71) Applicant: United Technologies Corporation, Farmington, CT (US)

(72) Inventors: Yu Long, Ithaca, NY (US); Yan Zhang, Vernon, CT (US); James T. Beals, West Hartford, CT (US)

(21) Appl. No.: 15/113,499

(22) PCT Filed: Feb. 5, 2015
(86) PCT No.: PCT/US2015/014649

§ 371 Date: Jul. 22, 2016

Related U.S. Application Data
(60) Provisional application No. 61/936,652, filed on Feb. 6, 2014.

(51) Int. Cl. B23K 26/342; B33Y 30/00; C21D 10/00; B23K 26/08; C22F 3/02; B33Y 10/00; B23K 26/06

(52) U.S. Cl. CPC B23K 26/342; B33Y 10/00; B33Y 30/00; B23K 26/0648; B23K 26/0608; B23K 26/0665; B23K 26/0876; C22F 3/02; C21D 10/00

(57) ABSTRACT

An additive manufacturing system includes an energy gun having a plurality of energy source devices each emitting an energy beam. A primary beam melts a selected region of a substrate into a melt pool and at least one secondary beam heat-conditions the substrate proximate the melt pool to reduce workpiece internal stress and/or enhance micro-structure composition of the workpiece.

This application claims priority to U.S. Patent Appln. No. 61/936,652 filed Feb. 6, 2014.

### BACKGROUND

The present disclosure relates to an additive manufacturing system and, more particularly, to an additive manufacturing system with a multi-energy beam gun and a method of operation.

Traditional additive manufacturing systems include, for example, Additive Layer Manufacturing (ALM) Systems, such as Direct Metal Laser Sintering (DMLS), Selective Laser Melting (SLM), Laser Beam Melting (LBM) and Electron Beam Melting (EBM) that provide for the fabrication of complex metal, alloy, polymer, ceramic and composite structures by the freeform construction of the workpiece, layer-by-layer. The principle behind additive manufacturing processes involves the selective melting of atomized precursor powder beds by a single directed energy source, producing the lithographic build-up of the workpiece. The energy source is focused and targeted onto localized regions of the powder bed producing small melt pools, followed by rapid solidification. This melting and solidification process is repeated many times to folio a single layer of the workpiece. Once a layer is completed, the powder bed is spread over the completed solidified layer and the process repeats as part of the layer-by-layer fabrication of the workpiece. These systems are typically directed by a three-dimensional model of the workpiece developed in a Computer Aided Design (CAD) software system.

The EBM System utilizes a single electron beam gun and the DMLS, SLM, and LBM Systems utilize a single laser as the energy source. Both system beam types are focused by a lens, then deflected by an electromagnetic scanner or rotating mirror so that the energy beam selectively impinges on the powder bed. The EBM System uses a beam of electrons accelerated by an electric potential difference and focused using electromagnetic lenses that selectively scan the powder bed.

Known ALM Systems have limited control over the heating and cooling cycles of the melt pools that can impact microstructure development of the workpiece and further lead to poor workpiece composition characteristics and properties.

### SUMMARY

An energy gun of an additive manufacturing system for producing a workpiece from a substrate according to one, non-limiting embodiment of the present disclosure includes a plurality of energy beams constructed and arranged to follow one-another.

In a further embodiment of the foregoing embodiment the plurality of energy beams includes a first energy beam for producing a melt pool from the substrate and a second energy beam for post heating to control a solidification rate of the melt pool.

In the alternative or additionally thereto, in the foregoing embodiment, the plurality of energy beams includes a first energy beam for producing a melt pool from the substrate and a second energy beam for pre-heating the substrate associated with the melt pool.

In the alternative or additionally thereto, in the foregoing embodiment, the substrate is a powder.

In the alternative or additionally thereto, in the foregoing embodiment, the plurality of energy beams have different frequencies.

In the alternative or additionally thereto, in the foregoing embodiment, the gun further includes a plurality of energy source devices wherein each one of the plurality of energy source devices emits a respective one of the plurality of energy beams.

In the alternative or additionally thereto, in the foregoing embodiment, the plurality of energy sources have fiber optic outputs.

In the alternative or additionally thereto, in the foregoing embodiment, each one of the plurality of energy beams impart a hot spot upon the substrate at pre-arranged distances from one-another and the plurality of energy source devices are constructed and arranged to move the hot spots in unison across the substrate at a controlled velocity.

In the alternative or additionally thereto, in the foregoing embodiment, the gun includes a lens for focusing at least one of the plurality of energy beams.

In the alternative or additionally thereto, in the foregoing embodiment, the plurality of energy beams are focused by the lens and the distance between the hot spots is dictated by the lens.

In the alternative or additionally thereto, in the foregoing embodiment, the gun includes a housing constructed and arranged to move at the controlled velocity, and the lens is stationary with respect to the housing and the plurality of energy source devices are constructed and arranged to move with respect to the housing to control the distance between the hot spots.

In the alternative or additionally thereto, in the foregoing embodiment, fiber optic outputs of each one of the plurality of energy source devices are pivoted to produce the movement of the plurality of energy source devices.

In the alternative or additionally thereto, in the foregoing embodiment, the gun includes a housing constructed and arranged to move at the controlled velocity, a plurality of lenses wherein the lens is one of the plurality of lenses, and each one of the plurality of lenses are supported by and stationary with respect to the housing and focus a respective one of the plurality of energy beams, and wherein the plurality of energy source devices are constructed and arranged to move with respect to the housing to control the distance between the hot spots.

In the alternative or additionally thereto, in the foregoing embodiment, the gun includes a beam combinatory, and at least one of the plurality of energy beams of respective at least one energy source devices being reflected upon the beam combinator and at least one of the plurality of energy beams of respective at least one energy source devices are refracted upon the beam combinator.

In the alternative or additionally thereto, in the foregoing embodiment, the combinator is orientated between the plurality of energy source devices and the lens.

In the alternative or additionally thereto, in the foregoing embodiment, the gun includes a housing constructed and arranged to move at the controlled velocity, and wherein the lens and beam combinator are supported by and stationary with respect to the housing, and wherein at least one of the energy source devices is constructed and arranged to move with respect to the housing to control the distance between the hot spots.

In the alternative or additionally thereto, in the foregoing embodiment, the gun includes a housing constructed and arranged to move at the controlled velocity, a plurality of lenses wherein the lens is one of the plurality of lenses, and wherein each one of the plurality of lenses are supported by and stationary with respect to the housing, focus a respective one of the plurality of energy beams of each respective energy source device, and are located between the beam combinator and the respective energy source device, and wherein at least one of the plurality of energy source devices are constructed and arranged to move with respect to the housing to control the distance between the hot spots.

An additive manufacturing system according to another, non-limiting, embodiment includes a primary energy beam for selectively melting a powder layer into a melt pool, a secondary energy beam for heat conditioning the substrate proximate to the melt pool, and a build table for supporting the powder layer.

A method of additively manufacturing a workpiece according to another, non-limiting, embodiment includes the steps of melting a substrate into a melt pool with a first energy beam, and heat conditioning the substrate with a second energy beam.

In a further embodiment of the foregoing embodiment, the method includes the step of pre-heating a region of the substrate with the second energy beam before melting the region into the melt pool by the first energy beam.

The foregoing features and elements may be combined in various combinations without exclusivity, unless expressly indicated otherwise. These features and elements as well as the operation thereof will become more apparent in-light of the following description and the accompanying drawings. It should be understood; however, that the following description and figures are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a schematic view of an additive manufacturing system according to one non-limiting embodiment of the present disclosure;

FIG. 2 is a schematic view of an energy gun of the additive manufacturing system;

FIG. 3 is a schematic view of the energy gun having adjustably moveable energy source devices;

FIG. 4 is a schematic view of a second embodiment of an energy gun;

FIG. 5 is a schematic view of a third embodiment of an energy gun;

FIG. 6 is an enlarge schematic view of a beam combinator of the energy gun of FIG. 5; and

FIG. 7 is a schematic view of a fourth embodiment of an energy gun.

### DETAILED DESCRIPTION

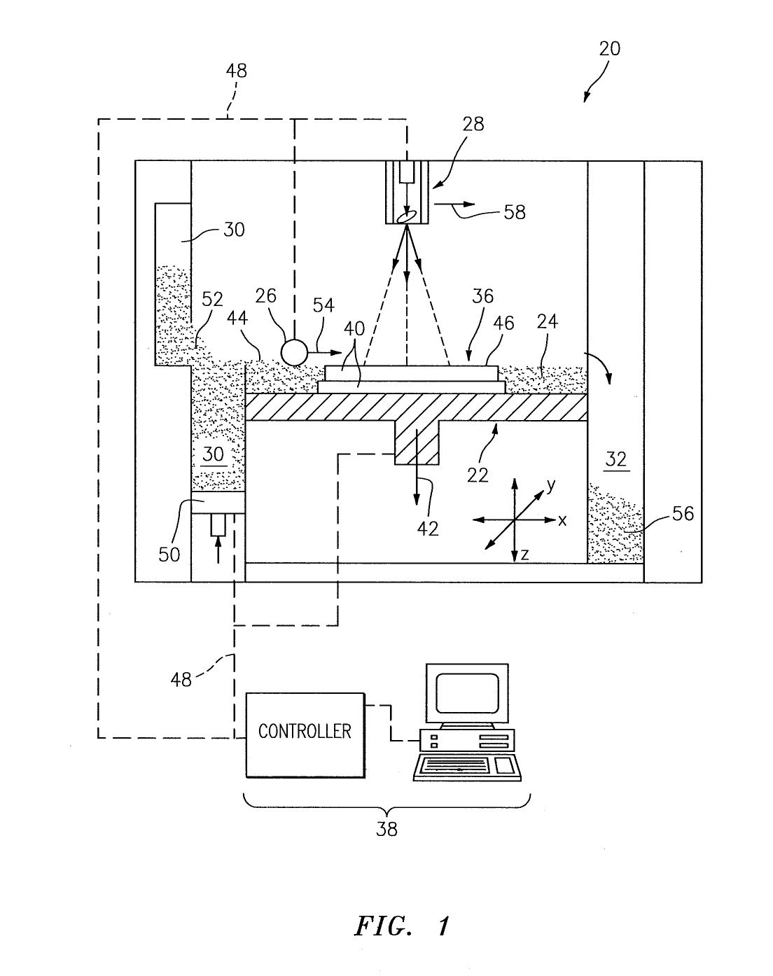

FIG. 1 schematically illustrates an additive manufacturing system 20 according to one non-limiting example of the present disclosure that may have a build table 22 for holding a powder bed 24, a particle spreader or wiper 26 for spreading the powder bed 24 over the build table, an energy gun 28 for selectively melting regions of a layer of the powder bed, a powder supply hopper 30 for supplying powder to the spreader 26, and a powder surplus hopper 32. The additive manufacturing system 20 may be constructed to build a workpiece 36 in a layer-by-layer fashion.

A controller 38 may have an integral CAD system for modeling the workpiece 36 into a plurality of slices 40 additively built atop one-another generally in a vertical or z-coordinate direction (see arrow 42). Once manufactured, each solidified slice 40 corresponds to a layer 44 of the powder bed 24 prior to solidification. The layer 44 is placed on top of a build surface 46 of the previously solidified slice 40. The controller 38 generally operates the entire system through a series of electrical and/or digital signals 48 sent to the system 20 components. For instance, the controller 38 may send a signal 48 to a mechanical piston 50 of the supply hopper 30 to sequentially push a supply powder 52 upward for receipt by the spreader 26, or alternatively or in addition thereto, the supply hopper 30 may feed powder downward via gravity. The spreader 26 may be a wiper, roller or other device that pushes (see arrow 54) or otherwise places the supply powder 52 over the build surface 46 of the workpiece 38 by a pre-determined thickness established through downward movement (see arrow 42) of the build table 22 controlled by the controller 38. Any excess powder 56 may be pushed into the surplus hopper 32 by the spreader 26. It is further contemplated and understood that the layer 44 may not be composed of a powder but may take the form of any substrate that may be layed or applied across the build surface 46 in preparation for melting.

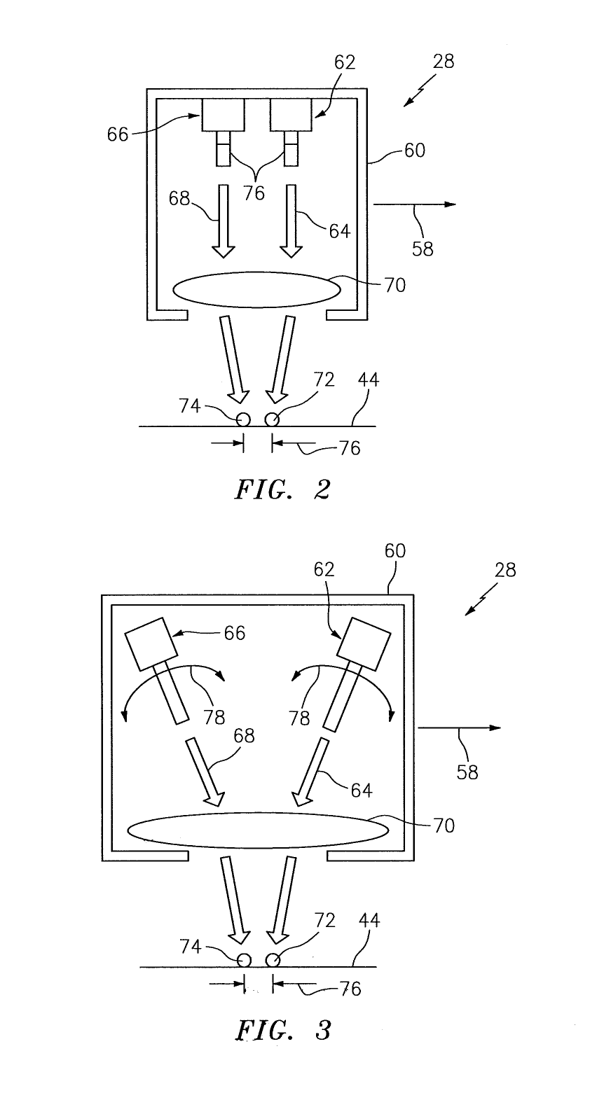

Once a substantially level powder layer 44 is established over the build surface 46, the controller 38 may send a signal 48 to the energy gun 28 to activate and generally move along the top layer 44 at a controlled velocity and direction (see arrow 58) and thereby selectively melt the top layer 44 on a region-by-region basis into melt pools. Referring to FIGS. 1 and 2, the energy gun 28 may have a housing 60, a primary energy source device 62 for emitting a primary energy beam 64, a secondary energy device 66 for emitting a secondary energy beam 68 for heat conditioning, and a lens 70 for focusing the energy beams 64, 68 upon the layer 44 and identified as respective hot spots 72, 74 on the layer. In FIG. 2, the devices 62, 66 and lens 70 are supported by, and held stationary with respect to, the housing 60. Each energy source device 62 may further include fiber optic outputs 76 that emit and direct the energy beams 64, 68.

The energy beams 64, 68 may be substantially parallel to one-another prior to being refracted through the lens 70. Once refracted and focused, the beams are redirected to form the hot spots 72, 74 at a pre-determined distance 76 away from one-another. That is, the lens 70 is chosen to establish the desired distance 76 between the hot spots. As illustrated, the primary hot spot 72 is the location of the desired melt pool region of the powder layer 44, and the secondary hot spot 74 is the desired location for post heating, thereby controlling the cool down rate (or solidification rate) of the melt pool. Control of the solidification rate may be desired to reduce internal stresses of the workpiece and/or control microstructure development such as directional grain structure as, for example, that found in single crystal alloys. The pre-established distance 76 is dependent upon many factors that may include but is not limited to the powder composition, the power of the energy source devices 62, 64, the velocity of the energy gun 28, and other parameters.

It is further contemplated and understood that the energy beams 64, 68 may be laser beams, electron beams or any other energy beams capable of heating the powder to sufficient temperatures and at sufficient rates. Each beam may operate with different frequencies to meet manufacturing objectives. For instance, beams with shorter wavelengths may heat up the powder faster than beams with longer wavelengths. Different optical frequencies or wavelengths typically requires different types of lasers; for example, CO2 lasers, diode lasers, and fiber lasers. However, to pre-select the best wavelength (thus laser type) for heating and/or melting, the wavelength selected may be based on the composition of the metal powder (for example). That is, particles of a powder may have different heat absorption rates impacting melting rates and solidification rates. Moreover, and besides wavelength, other properties of the beam may be a factor. For instance, pulsed laser beams or continuous laser beams may be desired to melt the powder. It is also understood that by interchanging the two energy source devices 62, 64, the secondary energy source device 64 may be used to pre-heat the desired region to be melted as oppose to post heating. Yet further the heat gun 28 may have two secondary energy source devices that both follow the primary source device for pre-heating and post-heating, respectively.

Referring to FIG. 3, the energy gun 28 may be further capable of moving the energy source devices 62, 64 in a tilting movement with respect to the housing 60 (see arrows 78) and generally along the same imaginary plane that contains the respective hot spots 72, 74. Controlled tilting of the devices 62, 64 may then adjust the distance 76 between the hot spots 72, 74 for any given parameters. With devices 62, 64 have adjustable tilt capability, the distance 76 is not (or is less) dependent upon the choice of lenses 70. It is further contemplated and understood that with a three dimensional lens 70, the movement of the energy source devices 62, 64 may also be three dimensional, thus enabling move complex operations of the system 20. Yet further, it is contemplated that movement of the energy source devices 62, 66 may be limited to the fiber optic outputs 76, thereby relying on the routing capability and flexibility of the fiber optic technology.

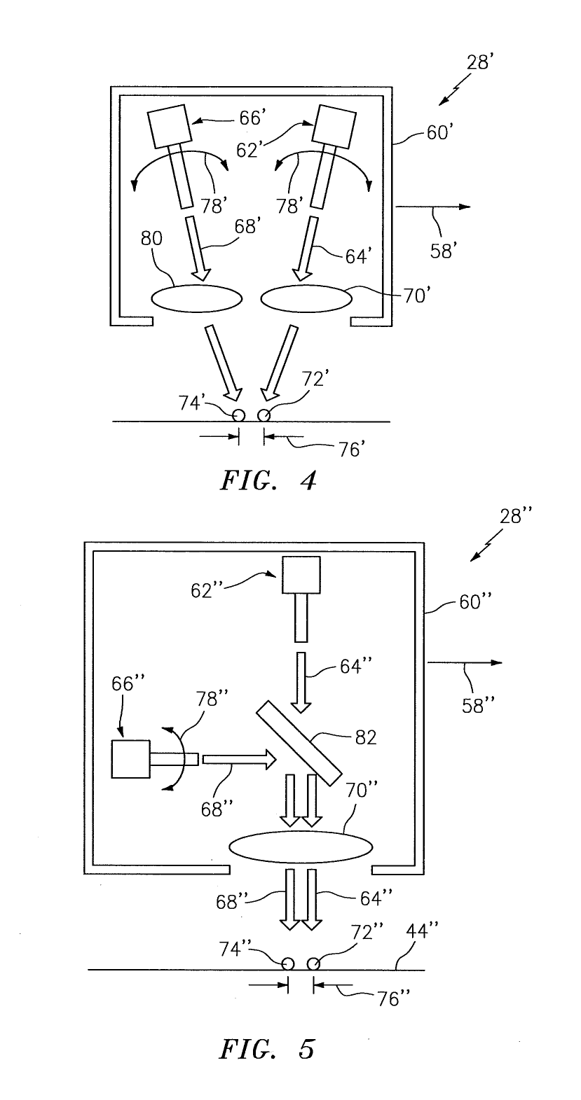

Referring to FIG. 4, a second, non-limiting, embodiment of the energy gun is illustrated wherein like components to the first embodiment have like identifying numerals except with the addition of a prime symbol. The energy gun 28′ of the second embodiment has a first lens 70′ for focusing a primary energy beam 64′ of a primary energy source device 62′. A second lens 80 focuses an energy beam 68′ of a secondary energy source device 66′. Both lenses 70′, 80 are supported by, and may be stationary with respect to, a housing 60′ and the devices 62′, 66′ are constructed and arranged to move or pivot to adjust a distance 76′ between hot spots 72′, 74′.

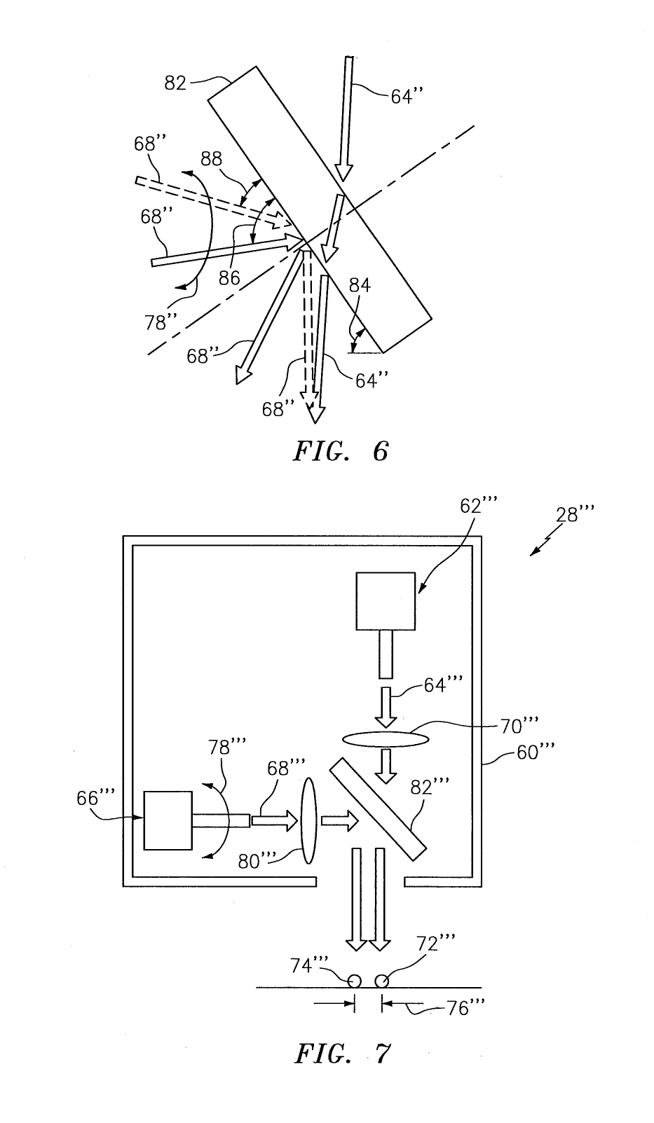

Referring to FIGS. 5 and 6, a third, non-limiting, embodiment of the energy gun is illustrated wherein like components to the first embodiment have like identifying numerals except with the addition of a double prime symbol. The energy gun 28″ of the third embodiment has a beam combinator 82 positioned between a lens 70″ and primary and secondary energy source devices 62″, 66″. The combinator 82 is supported by a housing 60″ and is positioned at a prescribed angle 84 with respect to the lens 70″ and/or a powder layer 44″. The angle 84 may be about forty-five degrees with the primary energy source 62″ located above the combinator 82 such that an energy beam 64″ emitted from the device 62″ is directed downward and refracted, first through the combinator 82 and then through the lens 70″. The device 62″, the combinator 82 and the lens 70″ may be supported by and stationary with respect to the housing 60″. The secondary energy source device 66″ may be positioned such that a secondary energy beam 68″ is adjustably directed horizontally to reflect off of the combinator 82 and then refracted through the lens 70″.

Device 66″ may be supported by the housing 60″ and may also be constructed and arranged to pivot, tilt, or move with respect to the housing such that the beam 68″ is adjustably reflected off of the beam combinator 82. As best shown in FIG. 6, a distance 76″ between hot spots 72″, 74″ may be adjusted by changing the incident reflection angle upon the combinator 82. More specifically, the beam 68″ may have a large reflection angle 86 producing a large distance between hot spots 72″, 74″. Moving or pivoting the energy source device 66″ to produce a smaller reflection angle 88 will reduce the distance 76″ between hot spots 72″, 74″. It is further contemplated and understood that the reflected beam 68″ may be held stationary and the energy source device 62″ emitting the energy beam 64″ may be adjustably pivoted or moved to adjust the refraction angle thereby adjusting the distance 76″.

Referring to FIG. 7, a fourth, non-limiting embodiment of an energy gun is illustrated wherein like elements to the second and third embodiments have like identifying numerals except with the addition of a triple prime symbol. In the fourth embodiment, an energy gun 28′″ has a primary energy beam 64′″ that is first focused through a lens 70′″ and then refracted through a beam combinator 82′″. A secondary energy beam 68′″ is first focused through a second lens 80′″ and then reflected off of the combinator 82′″. A secondary energy source device 66′″, emitting the secondary energy beam 68′″, may be constructed and arranged to pivot or move with respect to a housing 60′″ to adjust a distance 76′″ between respective hot spots 72′″, 74′″.

Referring to FIG. 6 and in operation as step 100, a CAD system as part of the controller 38 models the workpiece 36 in a slice-by-slice, stacked orientation. As step 102, a powder bed layer 44 is spread directly over the build table 22 per signals 48 sent from the controller 38. As step 104, the energy gun 28 then melts on a melt pool by melt pool basis a pattern upon the layer 44 mimicking the contour of a bottom slice 76 of the plurality of slices 40 as dictated by the controller 38. As step 106, the melted portion of the powder layer solidifies over a pre-designated time interval thereby completing the formation of a bottom slice 76. As step 108, the controller 38 communicates with the controller 96 of the ultrasonic inspection system 34 and the controller 96 initiates performance of an inspection to detect defects 66 in the bottom slice 76. As step 110 and if a defect is detected, the controllers communicate electronically with one-another and the bottom slice 76 is reformed by re-melting and re-solidification.

As step 112, a powder bed layer 44 is spread over the defect-free bottom slice 76. As step 114, at least a portion of the layer is melted by the energy gun 28 along with a meltback region of the solidified bottom layer 76 in accordance with a CAD pattern of a top slice dictated by the controller 38. As step 116 the melted layer solidifies forming the top slice 88 and a uniform and homogeneous interface 64. As step 118, the controller 38 communicates with the controller 96 and another ultrasonic inspection is initiated sending ultrasonic waves 82 through the bottom slice 76 and into the top slice 88. As step 120, the ultrasonic waves are in-part reflected off of any defects and in-part off of the build surface 46 of the top layer 88, received by the array 70 and processed by computer software. As step 122 and if a defect is detected, such as a delamination defect at the interface 64, the top slice 88 along with the meltback region is re-melted and re-solidified to remove the defects. The system 20 may then repeat itself forming yet additional slices in the same manner described and until the workpiece 36 is completed.

It is understood that relative positional terms such as “forward,” “aft,” “upper,” “lower,” “above,” “below,” and the like are with reference to the normal operational attitude and should not be considered otherwise limiting. It is also understood that like reference numerals identify corresponding or similar elements throughout the several drawings. It should be understood that although a particular component arrangement is disclosed in the illustrated embodiment, other arrangements will also benefit. Although particular step sequences may be shown, described, and claimed, it is understood that steps may be performed in any order, separated or combined unless otherwise indicated and will still benefit from the present disclosure.

The foregoing description is exemplary rather than defined by the limitations described. Various non-limiting embodiments are disclosed; however, one of ordinary skill in the art would recognize that various modifications and variations in light of the above teachings will fall within the scope of the appended claims It is therefore understood that within the scope of the appended claims, the disclosure may be practiced other than as specifically described. For this reason, the appended claims should be studied to determine true scope and content.

What is claimed is:

1. An energy gun of an additive manufacturing system for producing a workpiece from a substrate, the energy gun comprising:
a plurality of energy beams constructed and arranged to follow one-another.

2. The energy gun set forth in claim 1 wherein the plurality of energy beams includes a first energy beam for producing a melt pool from the substrate and a second energy beam for post heating to control a solidification rate of the melt pool.

3. The energy gun set forth in claim 1 wherein the plurality of energy beams includes a first energy beam for producing a melt pool from the substrate and a second energy beam for pre-heating the substrate associated with the melt pool.

4. The energy gun set forth in claim 1 wherein the substrate is a powder.

5. The energy gun set forth in claim 1 wherein the plurality of energy beams have different frequencies.

6. The energy gun set forth in claim 1 further comprising:
a plurality of energy source devices wherein each one of the plurality of energy source devices emits a respective one of the plurality of energy beams.

7. The energy gun set forth in claim 6 wherein the plurality of energy sources have fiber optic outputs.

8. The energy gun set forth in claim 6 wherein each one of the plurality of energy beams impart a hot spot upon the substrate at pre-arranged distances from one-another and the plurality of energy source devices are constructed and arranged to move the hot spots in unison across the substrate at a controlled velocity.

9. The energy gun set forth in claim 8 further comprising:
a lens for focusing at least one of the plurality of energy beams.

10. The energy gun set forth in claim 9 wherein the plurality of energy beams are focused by the lens and the distance between the hot spots is dictated by the lens.

11. The energy gun set forth in claim 10 further comprising:
a housing constructed and arranged to move at the controlled velocity; and
wherein the lens is stationary with respect to the housing and the plurality of energy source devices are constructed and arranged to move with respect to the housing to control the distance between the hot spots.

12. The energy gun set forth in claim 11 wherein fiber optic outputs of each one of the plurality of energy source devices are pivoted to produce the movement of the plurality of energy source devices.

13. The energy gun set forth in claim 9 further comprising:
a housing constructed and arranged to move at the controlled velocity;
a plurality of lenses wherein the lens is one of the plurality of lenses; and
wherein each one of the plurality of lenses are supported by and stationary with respect to the housing and focus a respective one of the plurality of energy beams, and wherein the plurality of energy source devices are constructed and arranged to move with respect to the housing to control the distance between the hot spots.

14. The energy gun set forth in claim 9 further comprising:
a beam combinator; and
wherein at least one of the plurality of energy beams of respective at least one energy source devices is reflected upon the beam combinator and at least one of the plurality of energy beams of respective at least one energy source devices are refracted upon the beam combinator.

15. The energy gun set forth in claim 14 wherein the combinator is orientated between the plurality of energy source devices and the lens.

16. The energy gun set forth in claim 15 further comprising:
a housing constructed and arranged to move at the controlled velocity; and
wherein the lens and beam combinator are supported by and stationary with respect to the housing, and wherein at least one of the energy source devices is constructed and arranged to move with respect to the housing to control the distance between the hot spots.

17. The energy gun set forth in claim 14 further comprising:
a housing constructed and arranged to move at the controlled velocity;
a plurality of lenses wherein the lens is one of the plurality of lenses; and
wherein each one of the plurality of lenses are supported by and stationary with respect to the housing, focus a respective one of the plurality of energy beams of each respective energy source device, and are located between the beam combinator and the respective energy source device, and wherein at least one of the plurality of energy source devices are constructed and arranged to move with respect to the housing to control the distance between the hot spots.

18. An additive manufacturing system comprising:
a primary energy beam for selectively melting a powder layer into a melt pool;
a secondary energy beam for heat conditioning the substrate proximate to the melt pool; and
a build table for supporting the powder layer.

19. A method of additively manufacturing a workpiece comprising the steps of:
melting a substrate into a melt pool with a first energy beam; and
heat conditioning the substrate with a second energy beam.

20. The method as set forth in claim 19 further comprising:
pre-heating a region of the substrate with the second energy beam before melting the region into the melt pool by the first energy beam.
